(19) United States
(12) Patent Application Publication
(10) Pub. No.: US 2010/0301618 A1
(43) Pub. Date: Dec. 2, 2010

(54) CABLE-ACTUATED INERTIAL LOCK FOR A VEHICLE DOOR

(75) Inventors: Terrence P. Costigan, Fenton, MI (US); Jeffrey L. Konchan, Romeo, MI (US); Frank J. Arabia, JR., Macomb, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/471,542

(22) Filed: May 26, 2009

(51) Int. Cl. E05B 65/10; E05B 65/00

(52) U.S. Cl. 292/93; 70/93

(57) ABSTRACT

A vehicle includes a door assembly having an outside door handle, a latching assembly, and a cable-actuated inertial lock having a moveable linkage disposed within a cavity of a stationary housing. A first end of the cable is connected to the handle, and a second end is connected to the linkage. The inertial lock includes a lever for actuating the latch under normal conditions when the handle is actuated, and also contains a deployable toggle piece that is stowed in the linkage. The toggle piece is configured to rotate within the linkage, and thereafter lock against a shaped inner surface of the housing in response to a threshold acceleration of the type set forth in FMVSS 206 or other standards. A torsion spring may be used to bias the toggle piece into a stowed position within the linkage.

### TECHNICAL FIELD

This invention relates to vehicle outside door assemblies having pull-bar outside handles and a passive locking device for preventing the opening of the vehicle door during a threshold acceleration event.

### BACKGROUND OF THE INVENTION

Outside door handle assemblies for modern vehicles typically utilize pull-bar handles that include a handle chassis. The chassis and any internally connected latching mechanism may be preassembled inside of a cavity of the vehicle door. To prevent the handle from inadvertently actuating during a threshold lateral and/or longitudinal acceleration, hereinafter referred to as a threshold acceleration event, vehicle door handle assemblies are required to meet certain performance standards. For example, the National Highway Transportation Safety Administration (NHTSA) of the United States Department of Transportation establishes various minimum performance requirements for a host of vehicle systems.

With respect to door handle assemblies in particular, Federal Motor Vehicle Safety Standard (FMVSS) 206 sets the threshold acceleration requirement noted above. In particular, §3.2.3 of FMVSS 206 requires that a vehicle door latching mechanism, when in an unlocked status, shall retain full latching capability at an acceleration of at least 294.2 meters/second², i.e., 30 g, in the longitudinal and lateral directions. The European Commission (EC) currently requires that door handle assemblies meet a similar 30 g minimum acceleration threshold.

Conventional door handle assemblies may be variously equipped to address these requirements, most often by employing counterweights or internal counterbalancing mechanisms. Such devices are relatively bulky and massive, and are typically installed on or packaged within the actuating portion of the door handle assembly at a position opposite a handle pivot or immediately adjacent to the door handle. The counterweights may be attached to a bell crank if such a device is used within the door handle assembly, while other methods or devices may be used in conjunction with door handles that do not use a bell crank. Regardless of the particular configuration of the door handle assembly, the relative size and mass of conventional inertial locking devices may render such devices less than optimal in certain design-related respects.

### SUMMARY OF THE INVENTION

Accordingly, an outside (O/S) door handle assembly for a vehicle door is provided having an inertial-actuated locking mechanism or an inertial lock. The O/S door handle assembly is cable-actuated. That is, motion of a pull-bar type O/S door handle applies tension to a length of cable, which ultimately unlatches the vehicle door to permit entry into the vehicle interior. The handle and the inertial lock are positioned at opposite ends of the cable. By locating the inertial lock away from the handle, and by eliminating the need for an internal bell crank, a considerable reduction in overall mass of the door assembly is possible relative to conventional door assemblies. Additionally, vehicle styling flexibility may be greatly enhanced.

The inertial lock is positioned at an end of the cable in proximity to the door latch, which in turn is enclosed within a separate door latch mechanism. A toggle piece of the inertial lock deploys into locking engagement with a stationary member or surface in response to the threshold acceleration. Deployment of the toggle piece prevents the handle from actuating beyond a point sufficient for unlatching the door. Another end of the cable is directly connected to the handle. Among other potential benefits, this particular configuration allows the handle assembly to be packaged within the door panel assembly in much closer proximity to the outer panel of the door, thus optimizing vehicle design flexibility as noted above.

In one embodiment, the inertial lock contains a housing, the toggle piece, and a moveable linkage. The housing is held stationary with respect to the linkage while the linkage moves within a cavity of the housing. The housing may be configured to capture one end of the cable, with the other end of the cable connected to the door handle. A sufficient movement of the handle pulls the linkage along within the cavity of the housing. The toggle piece may be stowed into another cavity or an opening of the linkage using a torsion spring or other suitable resilient biasing device.

In the presence of a threshold acceleration, e.g., the 30 g federal acceleration requirement mentioned above or any other desired acceleration value, the rotational biasing force of the torsion spring is overcome, thus allowing the toggle piece to quickly rotate into a deployed position. In the deployed position, the toggle piece engages a stationary member, e.g., a shaped or stepped internal surface of the housing or another suitable stationary member. Motion of the linkage within the cavity of the housing is thereby immediately arrested by direct contact between the deployed portion of the toggle piece and the housing, preventing the door from unlatching during the threshold acceleration event.

The above features and advantages, and other features and advantages, of the present invention are readily apparent from the following detailed description of the best mode for carrying out the invention when taken in connection with the accompanying drawings.

### BRIEF DESCRIPTION OF THE DRAWINGS

FIG. 1 is a schematic perspective side view of a vehicle having a door assembly with a pull-bar type door handle in accordance with the invention;

FIG. 2 is a schematic perspective partial interior view of a vehicle door assembly having a latching assembly and an inertial lock;

FIG. 3 is a schematic side view of the inertial lock shown in FIG. 2 and usable with the vehicle of FIG. 1;

FIG. 4 is a schematic partial cutaway plan view of a moveable linkage and toggle piece each usable with the inertial lock shown in FIGS. 2 and 3; and

FIG. 5 is a schematic partial cutaway side view of the inertial lock shown in FIGS. 2, 3, and 4.

### DESCRIPTION OF THE PREFERRED EMBODIMENTS

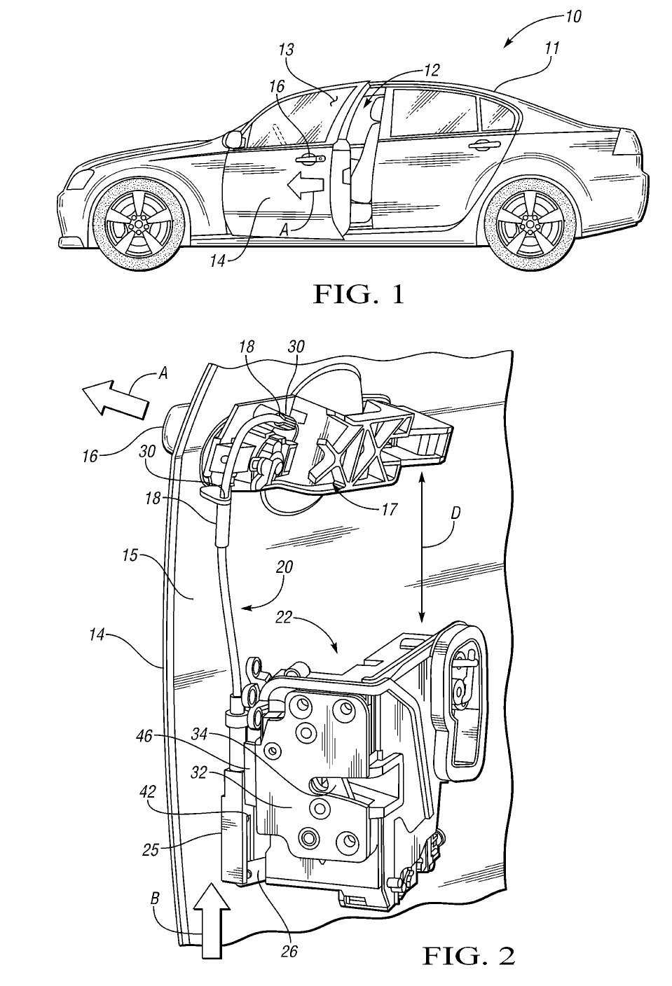

Referring to the drawings, wherein like reference numbers correspond to like or similar components throughout the several figures, and beginning with FIG. 1, a vehicle 10 includes a body 11 defining an interior 12. The body 11 may be configured as a sedan body as shown, or as a truck body, a sport utility vehicle body, a crossover vehicle body, or any other desired body style. Regardless of how the body 11 is configured, the vehicle 10 includes at least one door assembly or door 14 having window glass 13 and a pull-bar type outside (O/S) door handle 16 configured to facilitate entry into the interior 12. That is, when the door 14 remains latched but unlocked, a threshold force exerted on the handle 16 in a direction indicated by arrow A will open the door 14.

Referring to FIG. 2, the handle 16 is connected to an inner assembly 17 and a latching mechanism 22 via an inertial lock 24. The inertial lock 24 is, as noted elsewhere hereinabove, cable-actuated and adapted to prevent the handle 16 from actuating, or more precisely to prevent the door 14 of FIG. 1 from unlatching, during a threshold vehicle acceleration event. Such an event may be an acceleration exceeding the 30 g standard noted above or any other acceleration threshold.

The handle 16 may be connected to the outside of the door 14 using the inner assembly 17 such that a panel 15 of the door 14 is positioned between the handle 16 and the inner assembly 17. The handle 16 is also connected to the latching mechanism 22 via a length of cable 20. For proper alignment, positioning, and/or strain relief of the cable 20, the inner assembly 17 may include one or more guide members 18.

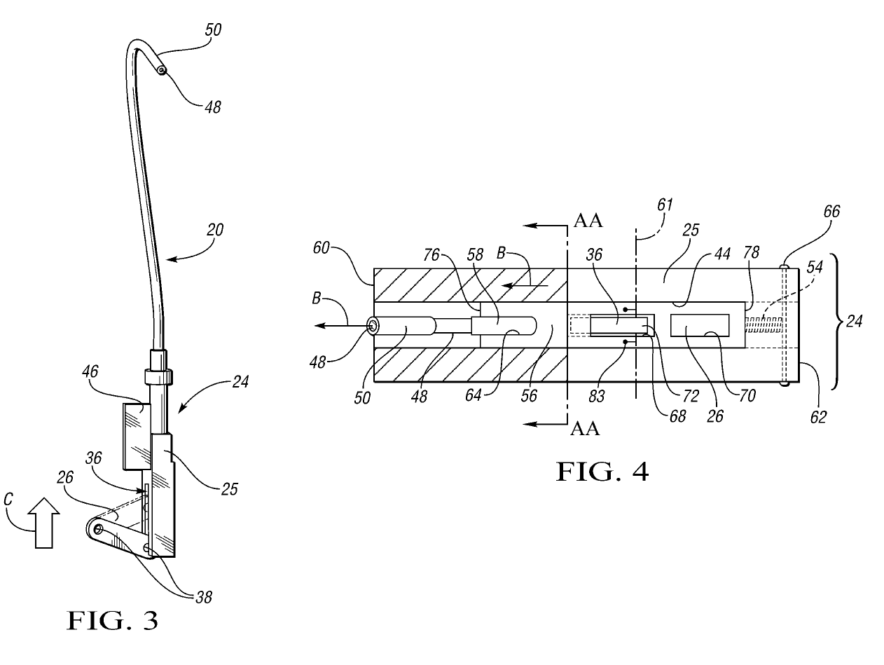

In one embodiment, the guide member(s) 18 may each define a circular through-opening 30 adapted for receiving the cable therein and for securing the cable 20 to the inner assembly 17, although the guide members 18 may be constructed in other ways without departing from the intended scope of the invention. The number and location of guide members 18 may be varied as needed to properly orient the cable 20 in a generally vertical direction relative to the latching mechanism 22, such that strain on the cable 20 is sufficiently minimized and the motion of a wire or wires 48 (see FIG. 3) therein is not impinged.

Still referring to FIG. 2, the latching mechanism 22 may include an end bracket or latch plate 32 and a moveable latch 34. As noted above, the latching mechanism 22 may be separated from the inner assembly 17 by a suitable distance, as represented in FIG. 2 by double-sided arrow D. Operation of a vehicle door latch such as the latching mechanism 22, and in particular the ability to selectively move a latch such as the latch 34 with respect to a locking bar of a vehicle door, will be well understood by those of ordinary skill in the art, and therefore this particular functionality and structure is not set forth in detail herein.

During normal operation, i.e., when a person wishes to enter the interior 11 of the vehicle 10 shown in FIG. 1, the handle 16 is pulled in the direction of arrow A. Motion of the handle 16 in that direction applies tension to a wire 48 (see FIG. 3) or a bundle of such wires of cable 20. The wire 48 slides or moves in the direction of arrow B within an outer sheath or conduit 50 of the cable 20, also as shown and described below with reference to FIG. 3. A lever 26 is ultimately pulled during the movement of the wire 48, also in the direction of arrow C, to thereby trip the latch 34 of the latching mechanism 22. The door 14 of FIG. 1 is thereby caused to open.

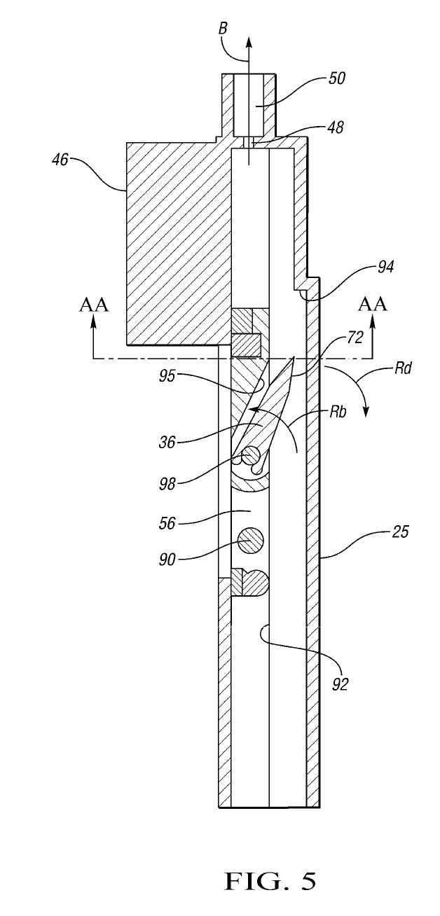

The inertial lock 24 includes a stationary housing 25 which receives and secures the cable 20 via the linkage 56 contained therein, as shown in FIGS. 4 and 5 and discussed below. The housing 25 may be molded of lightweight plastic or resin in one embodiment, and may be provided with an indexing member or tab 46. In one embodiment, the tab 46 may be formed integrally with the housing 25 as a unitary piece. The tab 46 may be secured to and/or entrapped by the latch plate 32 or another suitable portion of the latching mechanism 22 to sufficiently orient and/or secure the inertial lock 24 to the latching mechanism 22.

Referring to FIG. 3, the inertial lock 24 is connected to one end of the cable 20 as noted above such that a tensile force acting on the other end of the cable 20, i.e., the end connected to the handle 16 shown in FIGS. 1 and 2, ultimately pulls or moves the lever 26 in the direction of arrow C to open the latch 34 (see FIG. 2). The components of the inertial lock 24 may be constructed of any suitable strong but lightweight material such as but not limited to molded plastic, metal, resin, etc. The housing 25 may be provided with a slot 42, and includes internal surfaces 44 (see FIG. 4) which define an internal cavity within which the linkage 56 is moveably disposed.

The lever 26 may be shaped or configured as needed to provide the desired latch-opening functionality. However configured, the lever 26 is coupled with the linkage 56 in such a manner as to freely move within the slot 42 when the handle 16 of FIGS. 1 and 2 is actuated, other than during instances when such actuation is attempted during a threshold vehicle acceleration event, wherein the deployment of the toggle piece 36 prevents such motion. When the handle 16 is released, a return spring 54 (see FIG. 4) or other suitable return device moves the linkage 56 and lever 26 back to their initial positions.

Referring to FIG. 4, a partial cutaway view of the inertial lock 24 to the left of arrows AA show certain internal detail, with the portions appearing to the right of arrows AA showing the lock 24 in plan view. The housing 25 of the inertial lock 24 has a first end 60 and a second end 62, and the linkage 56 likewise has a first end 76 and a second end 78. During normal operation of the handle 16 of FIGS. 1 and 2, tension in the direction of arrow B is applied to the wire 48 of cable 20 to pull on the first end 76 of the linkage 56 such that the linkage 56 is pulled along within the housing 25 in the direction of arrow B.

The lever 26 (also see FIGS. 2 and 3) may be inserted into a first opening 70 of the linkage 56 and rigidly fastened to the linkage 56, e.g., using one or more mounting holes 38 as shown in FIG. 3 in conjunction with a cross member 90 (see FIG. 5). Movement of the linkage 56 therefore moves the connected lever 26, which in turn actuates the latch 34 shown in FIG. 2. When a threshold acceleration event occurs, however, the toggle piece 36 rotates about an axis 61 such that a shaped end 72 or other suitable surface of the toggle piece 36 is permitted to rotate within the linkage 56 to engage the housing.

The toggle piece 36 may be stowed within a recess or opening 68 of the linkage 56. The linkage 56 may also be configured to secure an end of the cable 20. For example, the cable 20 may be configured to terminate in a cap or a plug 58 that may be securely connected to end 76 of the linkage 56, e.g., press-fit or bonded within a slot 64 formed in the linkage 56. End 78 of the linkage 56 may secure an end of the spring 54, with the other end of the spring 54 likewise secured to the housing 25, if necessary using a cross piece or connecting member 66.

Referring to FIG. 5, in normal operation the spring 83 holds the toggle piece 36 in close proximity to a first inner surface 95 of the linkage 56. During a threshold vehicle acceleration event, the force of the acceleration quickly exceeds a pre-calibrated biasing force or torsion of the spring 83 of FIG. 4 acting in the direction of arrow Rb, thus allowing the toggle piece 36 to quickly rotate or deploy about a pivot 98 away from surface 95 in the direction of arrow Rd. The shaped end 72 of the toggle piece 36 thereafter contacts a reaction surface 94, such as a shaped or a stepped inner surface of the housing 25 in the embodiment shown in FIG. 5. Once engaged with the reaction surface 94, the linkage 56 is prevented from moving any further along a shelf 92 of the housing 25 in the direction of arrow B, and the door 14 of FIG. 1 is prevented from opening. Although the lever 26 of FIG. 3 is omitted from FIG. 5 for simplicity, the lever 26 may be connected to the linkage 56 at holes 38 (see FIG. 3) via a cross member(s) 90 or other suitable connecting means.

To ensure proper deployment of the toggle piece 36 within the linkage 56, the toggle piece should be properly weighted to provide the desired deployment response during the threshold acceleration. For example, the toggle piece 36 may be constructed of a die cast metal or other material having sufficient mass for the desired threshold acceleration, toggle piece 36, and torsion of the spring 83. Alternately, an integral or connected mass may be connected to the shaped end 72 of the toggle piece 36 to provide the required moment about pivot 98.

As noted above, separating the inertial lock 24 from the handle 16 of FIGS. 1 and 2 and locating the inertial lock 24 away from the handle 16 allows the handle 16 and its inner assembly 17 (see FIG. 2) to be packaged much closer to the window glass 13 (see FIG. 1). This configuration may be conducive to enhanced vehicle styling options. Potentially, the use of the inertial lock 24 may lead to a streamlined design of the doors 14 and vehicle 10 of FIG. 1, allowing improvement not only of the aesthetic appeal of a given vehicle using such a door assembly, but also potentially improving fuel economy. Likewise, by eliminating the mass and required packaging space of a conventional counterweight system, the overall weight of the vehicle 10 of FIG. 1 may be reduced, potentially improving on fuel economy in this additional way.

While the best modes for carrying out the invention have been described in detail, those familiar with the art to which this invention relates will recognize various alternative designs and embodiments for practicing the invention within the scope of the appended claims.

1. A vehicle comprising:
a door assembly having an outside door handle and a latching mechanism;
a moveable linkage having a lever for actuating the latching mechanism, and containing an inertial lock, wherein the inertial lock includes a deployable toggle piece adapted for selectively preventing actuation of the latching mechanism during a threshold acceleration;
a housing having a reaction surface; and
a cable having a first end connected to the door handle and a second end connected to the linkage;
wherein the toggle piece is adapted to rotate within the linkage in response to the threshold acceleration to thereby engage the reaction surface and prevent the latching mechanism from actuating.

2. The vehicle of claim 1, further comprising a torsion spring configured for biasing the toggle piece into a stowed position within the linkage prior to deployment of the toggle piece.

3. The vehicle of claim 1, wherein the housing includes an inner shelf, and wherein the linkage is moveable within the cavity via the cable along the shelf.

4. The vehicle of claim 3, wherein the housing includes a tab for indexing the housing to the latching mechanism.

5. The vehicle of claim 4, wherein the tab is an axial tab formed integrally with the housing.

6. A vehicle door assembly comprising:
an outside door handle and a latching mechanism;
a moveable linkage having a lever for actuating the latching mechanism, and containing an inertial lock having a deployable toggle piece that selectively prevents the actuation of the latching mechanism during a threshold acceleration;
a housing having a reaction surface; and
a cable having a first end connected to the handle and a second end connected to a first end of the linkage, wherein a motion of the handle pulls the linkage to actuate the latching mechanism unless prevented from doing so by a deployment of the toggle piece during the threshold acceleration;
wherein the toggle piece deploys by rotating within the linkage in response to the threshold acceleration, thereby engaging the reaction surface to prevent the latching mechanism from actuating.

7. The vehicle door assembly of claim 6, wherein the linkage is positioned within an internal cavity of the housing and is selectively moveable therewithin via the cable when the handle is actuated.

8. The vehicle door assembly of claim 7, wherein the housing has a tab member for positioning the housing with respect to the latching mechanism.

9. The vehicle door assembly of claim 6, further comprising a torsion spring for biasing the toggle piece into a stowed position within the linkage.

10. The vehicle door assembly of claim 6, further comprising a return spring connected to the linkage and adapted for moving the linkage after actuation of the handle.

11. An inertial lock for use with a vehicle door assembly having an outside door handle, the inertial lock comprising:
a housing defining an internal cavity;
a linkage that is selectively moveable within the cavity in response to a motion of the handle;
a lever connected to the linkage and configured to actuate a latching mechanism of the door assembly;
a deployable toggle piece configured to rotate in response to a threshold vehicle acceleration; and
a cable having a first end connected to the handle and a second end connected to the linkage;
wherein the toggle piece deploys in response to the threshold vehicle acceleration by rotating into locking engagement with a reaction surface of the housing to prevent actuation of the latching mechanism.

12. The inertial lock of claim 11, wherein the housing includes a tab for indexing the housing to the latching mechanism.

13. The inertial lock of claim 11, further comprising a torsion spring adapted for biasing the toggle piece into a stowed position.

14. The inertial lock of claim 11, further comprising a return spring connected to the linkage and adapted for moving the linkage after actuation of the handle.
